(19) United States
(12) Patent Application Publication
(10) Pub. No.: US 2013/0266322 A1
(43) Pub. Date: Oct. 10, 2013

(54) Infrared Remote Control Switching Method Through A Wireless Transmission

(71) Applicant: Shan-Gow Lo, Tainan City (TW)

(72) Inventor: Shan-Gow Lo, Tainan City (TW)

(21) Appl. No.: 13/442,942

(22) Filed: Apr. 10, 2012

(51) Int. Cl. H04B 10/00

(52) U.S. Cl. 398/111

(57) ABSTRACT

An infrared remote control switching method includes providing a hand-held device, loading a program into the hand-held device, driving the program in the hand-held device to select and set a desired electronic product, driving the hand-held device into a remote control mode, and transmitting an infrared signal through an adapter to the desired electronic product so as to remote control the desired electronic product. Thus, the program is loaded into the hand-held device in a wireless transmission manner and can be updated to search the codes corresponding to and compatible with various electronic products so that the hand-held device can be reset and converted into a universal remote controller which can be used to remote control various electronic products through the adapter.

### BACKGROUND OF THE INVENTION

1. Field of the Invention

The present invention relates to a method and, more particularly, to an infrared remote control switching method through a wireless transmission.

2. Description of the Related Art

A remote controller is usually used to remote control in a wireless transmission manner an electronic product, including a TV, a GAME, a DVD or an AUDIO. In addition, the remote controller can also be used to remote control an object, such as a car door, a refrigerator, a house door, an electronic lock and the like. However, the electronic product cannot be operated when the remote controller is worn out or missed, thereby causing inconvenience to the user. A universal remote controller can be used to remote control various electronic products. The universal remote controller has to detect and set the codes (including brand, type and the like) of the desired electronic product so as to connect the wireless signal of the desired electronic product. However, if the universal remote controller cannot detect the codes of the desired electronic product, the universal remote controller will fail.

### BRIEF SUMMARY OF THE INVENTION

In accordance with the present invention, there is provided an infrared remote control switching method through a wireless transmission, comprising providing a hand-held device, including an Android cell phone, i-pod or i-phone, loading a program, including Apps, into the hand-held device in a wireless transmission manner, including a wireless transmission technology of wireless fidelity (WiFi) or bluetooth, driving the program in the hand-held device to select at least one desired electronic product, including a TV, a DVD or an AUDIO, setting a brand and a type of the desired electronic product, driving the hand-held device into a remote control mode with the hand-held device functioning as a remote controller, modulating an infrared signal from the hand-held device into a modulated infrared signal, transmitting the modulated infrared signal to an adapter which processes the modulated infrared signal to form a processed infrared signal, and transmitting the processed infrared signal through the adapter to the desired electronic product so as to remote control the desired electronic product in a wireless transmission manner.

The program integrates codes of various electronic products and is updated in a wireless transmission manner, and the hand-held device can set more than one electronic product simultaneously. The adapter receives the modulated infrared signal from the hand-held device in a wireless transmission manner after the hand-held device enters the remote control mode. The adapter is disposed at an effective transmission distance from the electronic product to be remote controlled. The adapter receives the modulated infrared signal from the WiFi or bluetooth, demodulates the modulated infrared signal to return the modulated infrared signal to an original infrared signal, and transmits the original infrared signal to the electronic product. Alternatively, the adapter receives the modulated infrared signal from the WiFi or bluetooth, demodulates the modulated infrared signal into an infrared code which is agreed in a MCU microprocessor oscillator of the adapter, and transmits the infrared code to the electronic product.

The primary objective of the present invention is to provide an infrared remote control switching method through a wireless transmission.

According to the primary advantage of the present invention, the program is loaded into the hand-held device in a wireless transmission manner and can be updated to search the codes corresponding to and compatible with various electronic products so that the hand-held device can be reset and converted into a universal remote controller which can be used to remote control various electronic products through the adapter, thereby facilitating the user operating the electronic products, and thereby enhancing the versatility of the hand-held device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of an infrared remote control switching method through a wireless transmission in accordance with the preferred embodiment of the present invention.

FIG. 2 is a schematic diagram showing setting of a hand-held device in accordance with the preferred embodiment of the present invention.

FIG. 3 is a block diagram of an adapter in accordance with the preferred embodiment of the present invention.

FIG. 4 is a schematic operational view showing co-operation of the hand-held device and the adapter in accordance with the preferred embodiment of the present invention.

### DETAILED DESCRIPTION OF THE INVENTION

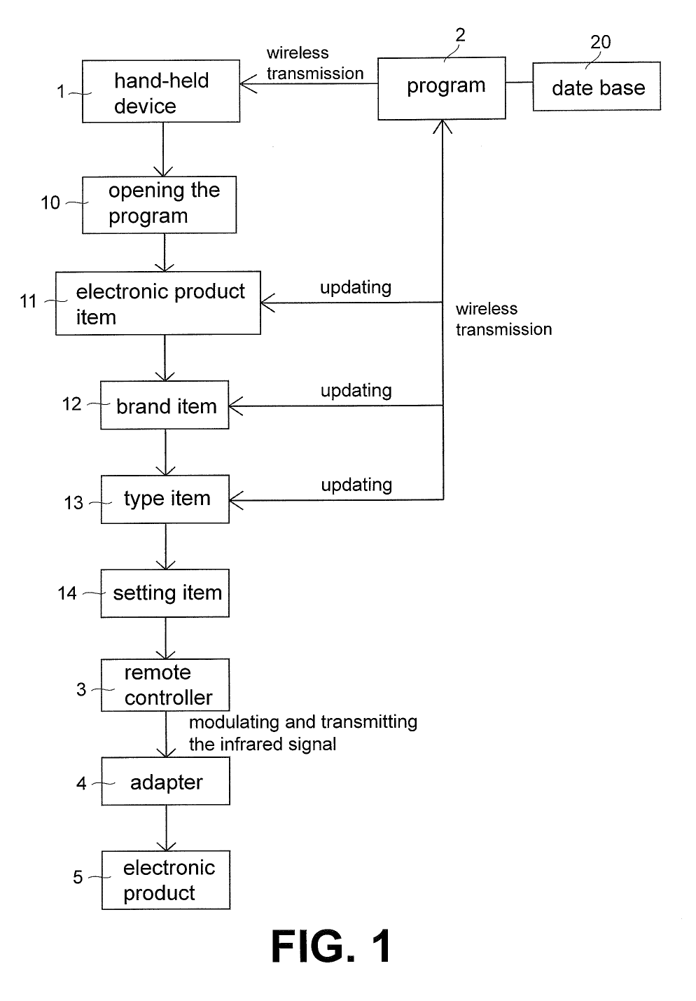

Referring to the drawings and initially to FIG. 1, an infrared remote control switching method through a wireless transmission in accordance with the preferred embodiment of the present invention comprises providing a hand-held device 1 with a wireless transmission function, and loading a program 2 into the hand-held device 1. The hand-held device 1 is a mobile device and includes an Android cell phone, i-pod or i-phone. The wireless transmission function of the hand-held device 1 includes a wireless transmission technology of wireless fidelity (WiFi) or bluetooth. The program 2 includes multiple applications (Apps) and is provided with a date base 20. The program 2 is connected with the hand-held device 1 in a wireless transmission manner. Then, the program 2 is opened to let the hand-held device 1 enter an electronic product item 11 to select a desired electronic product, including a television (TV), a digital video disc (DVD) or an audio recorded (AUDIO). If the electronic product item 11 in the hand-held device 1 does not satisfy the user's requirement, the electronic product item 11 is connected with the program 2 in a wireless transmission manner so that the program 2 searches the date base 20 so as to update the electronic product item 11. Then, the hand-held device 1 enters a brand item 12 so as to select the brand of the desired electronic product. If the brand item 12 in the hand-held device 1 does not satisfy the user's requirement, the brand item 12 is connected with the program 2 in a wireless transmission manner so that the program 2 searches the date base 20 so as to update the brand item 12. Then, the hand-held device 1 enters a type item 13 so as to select the type or number of the desired electronic product. If the type item 13 in the hand-held device 1 does not satisfy the user's requirement, the type item 13 is connected with the program 2 in a wireless transmission manner so that the program 2 searches the date base 20 so as to update the type item 13. After the process of the type item 13 is finished, the hand-held device 1 enters a setting item 14 so as to confirm the settings of the desired electronic product. After the process of the setting item 14 is finished, the hand-held device 1 is converted into a remote controller 3. In such a manner, the remote controller 3 initially modulates an infrared signal and then emits the modulated infrared signal to an adapter 4 which has a wireless receiving function. Then, the adapter 4 processes the modulated infrared signal from the remote controller 3 and transmits the processed signal to an electronic product 5 to remote control the electronic product 5.

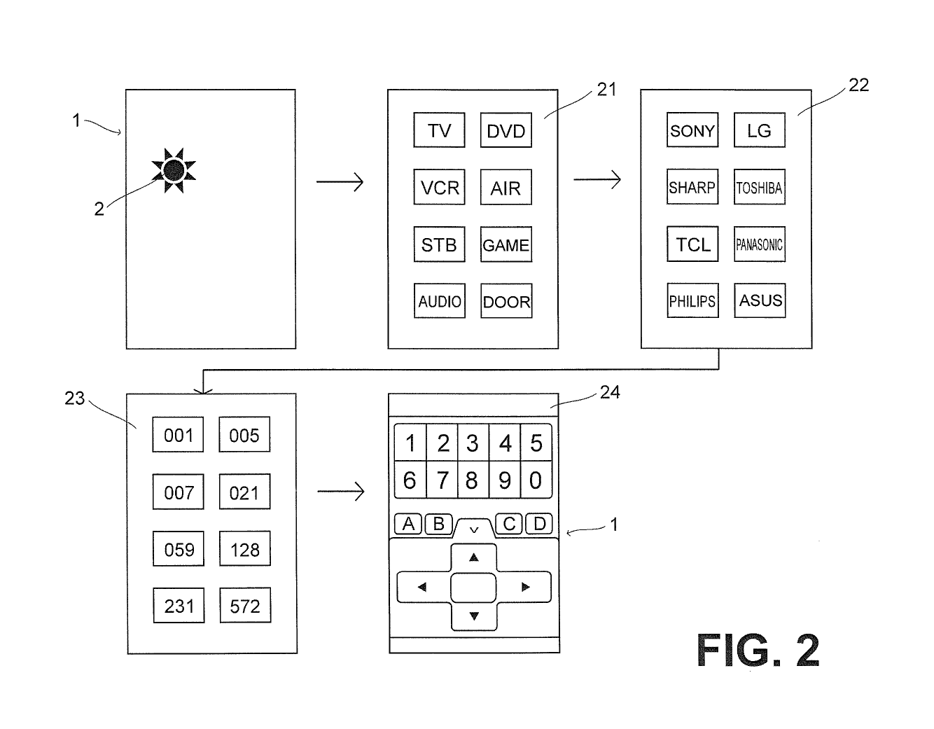

Referring to FIG. 2 with reference to FIG. 1, after the program 2 is loaded into the hand-held device 1, the program 2 is opened to let the hand-held device 1 enter the electronic product item 11. At this time, a first picture 21 is shown on the hand-held device 1 so that the user can select a desired electronic product, including TV, DVD, VCR, AIR, STB, GAME, AUDIO or DOOR. After the user has chosen a desired electronic product, the hand-held device 1 enters the brand item 12. At this time, a second picture 22 is shown on the hand-held device 1 so that the user can select the brand of the desired electronic product, including SONY, LG, SHARP, TOSHIBA, TCL, PANASONIC, PHILIPS or ASUS. After the user has chosen the brand of the desired electronic product, the hand-held device 1 enters the type item 13. At this time, a third picture 23 is shown on the hand-held device 1 so that the user can select the type of the desired electronic product, including 001, 005, 007, 021, 059, 128, 231 or 572. After the process of the type item 13 is finished, the hand-held device 1 enters the setting item 14 so that the user can confirm the settings of the desired electronic product. After the process of the setting item 14 is finished, the hand-held device 1 is converted into a universal remote controller 3. At this time, a fourth picture 24 is shown on the hand-held device 1 so that the hand-held device 1 functions as a universal remote controller 3, and the user can operate the remote controller 3 to remote control various electronic products 5 through the adapter 4.

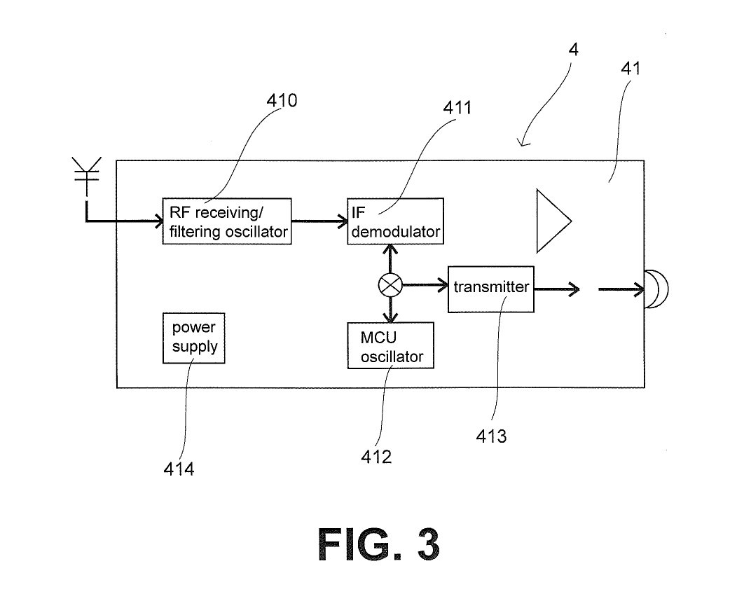

Referring to FIG. 3 with reference to FIG. 1, the adapter 4 includes a circuit board 41, a power supply 414 mounted on the circuit board 41, a RF receiving/filtering oscillator 410 mounted on the circuit board 41, an IF demodulator 411 mounted on the circuit board 41 and connected with the RF receiving/filtering oscillator 410, a MCU microprocessor oscillator 412 mounted on the circuit board 41 and connected with the IF demodulator 411, and an infrared transmitter 413 mounted on the circuit board 41 and connected with the IF demodulator 411 and the MCU microprocessor oscillator 412. In operation, the power supply 414 of the adapter 4 is conducted. Then, the RF receiving/filtering oscillator 410 of the adapter 4 receives the modulated infrared signal from the remote controller 3. Then, the IF demodulator 411 of the adapter 4 demodulates the modulated infrared signal from the remote controller 3. At the same time, the MCU microprocessor oscillator 412 of the adapter 4 processes (including matches, connect and gather) the demodulated infrared signal from the IF demodulator 411. Then, the infrared transmitter 413 of the adapter 4 transmits the processed infrared signal from the MCU microprocessor oscillator 412 to the electronic product 5. Thus, the user can operate the remote controller 3 to remote control the electronic product 5 through the adapter 4.

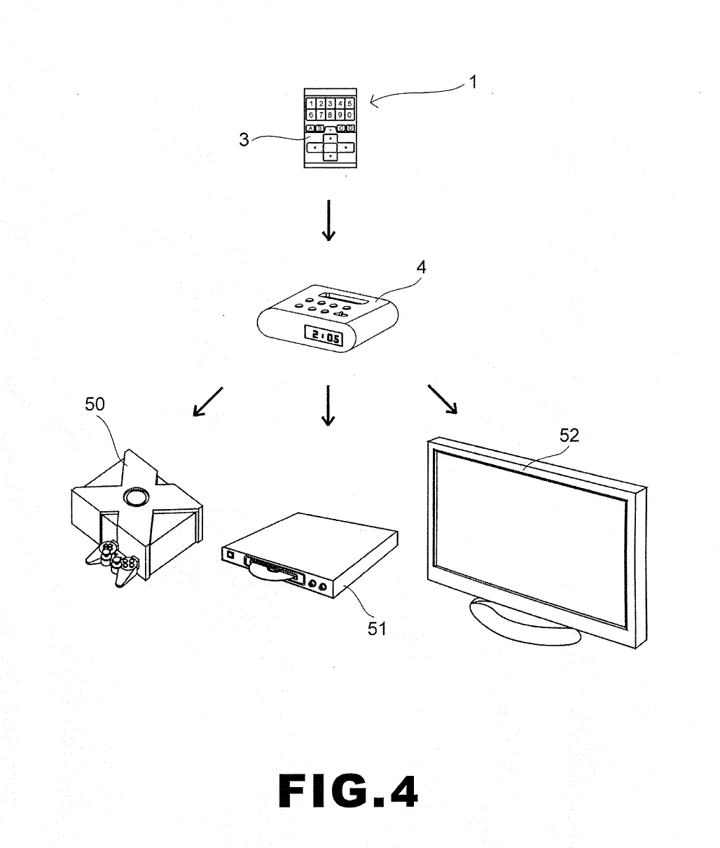

Referring to FIG. 4 with reference to FIGS. 1-3, after the hand-held device 1 is converted into a universal remote controller 3, the remote controller 3 initially modulates an infrared signal from the WiFi or bluetooth and then emits the modulated infrared signal to the adapter 4 in a wireless transmission manner. Then, the adapter 4 processes the modulated infrared signal from the remote controller 3 and transmits the processed infrared signal to an electronic product 5, including a game player 50, a DVD 51 or a television 52. Thus, the user can operate the remote controller 3 to remote control the electronic product 5 through the adapter 4.

In practice, the adapter 4 is disposed at an effective transmission distance from the electronic product 5 so that the adapter 4 can receive the modulated infrared signal from the WiFi or bluetooth. After the adapter 4 receives the modulated infrared signal, the adapter 4 demodulates the modulated infrared signal to return the modulated infrared signal to the original infrared signal and then transmits the original infrared signal to the electronic product 5 so that the adapter 4 can transmit the original remote control signal in a directionless and long-distance manner. Preferably, the adapter 4 has a data base of multiple infrared remote control codes, and the data base of the adapter 4 is built in the hand-held device 1. Alternatively, the adapter 4 demodulates the modulated infrared signal into an infrared code which is agreed in the MCU microprocessor oscillator 412 and then transmits the infrared code. Thus, the data base of the infrared remote control codes is built in the MCU microprocessor oscillator 412 of the adapter 4.

Accordingly, the program 2 is loaded into the hand-held device 1 in a wireless transmission manner and can be updated to search the codes corresponding to and compatible with various electronic products 5 so that the hand-held device 1 can be reset and converted into a universal remote controller 3 which can be used to remote control various electronic products 5 through the adapter 4, thereby facilitating the user operating the electronic products 5, and thereby enhancing the versatility of the hand-held device 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An infrared remote control switching method through a wireless transmission, comprising:
providing a hand-held device, including an Android cell phone, i-pod or i-phone;
loading a program, including Apps, into the hand-held device in a wireless transmission manner, including a wireless transmission technology of wireless fidelity (WiFi) or bluetooth;
driving the program in the hand-held device to select at least one desired electronic product, including a TV, a DVD or an AUDIO;
setting a brand and a type of the desired electronic product;
driving the hand-held device into a remote control mode with the hand-held device functioning as a remote controller;
modulating an infrared signal from the hand-held device into a modulated infrared signal;
transmitting the modulated infrared signal to an adapter which processes the modulated infrared signal to form a processed infrared signal; and
transmitting the processed infrared signal through the adapter to the desired electronic product so as to remote control the desired electronic product in a wireless transmission manner.

2. The infrared remote control switching method through a wireless transmission of claim 1, wherein the program integrates codes of various electronic products and is updated in a wireless transmission manner, and the hand-held device can set more than one electronic product simultaneously.

3. The infrared remote control switching method through a wireless transmission of claim 1, wherein the adapter receives the modulated infrared signal from the hand-held device in a wireless transmission manner after the hand-held device enters the remote control mode.

4. The infrared remote control switching method through a wireless transmission of claim 1, wherein the adapter is disposed at an effective transmission distance from the electronic product to be remote controlled.

5. The infrared remote control switching method through a wireless transmission of claim 1, wherein the adapter receives the modulated infrared signal from the WiFi or bluetooth, demodulates the modulated infrared signal to return the modulated infrared signal to an original infrared signal, and transmits the original infrared signal to the electronic product.

6. The infrared remote control switching method through a wireless transmission of claim 1, wherein the adapter receives the modulated infrared signal from the WiFi or bluetooth, demodulates the modulated infrared signal into an infrared code which is agreed in a MCU microprocessor oscillator of the adapter, and transmits the infrared code to the electronic product.
